(19) United States
(12) Patent Application Publication
(10) Pub. No.: US 2008/0064350 A1
(43) Pub. Date: Mar. 13, 2008

(54) System and method for dailing a telephone number

(75) Inventor: Yair Winkler, Caesarea (IL)

Correspondence Address: BROWDY AND NEIMARK, P.L.L.C.;624 NINTH STREET, NW, SUITE 300, WASHINGTON, DC, 20001-5303, US

(73) Assignee: Simphonick Holdings Ltd., Tel Aviv (IL)

(21) Appl. No.: 11/519,776

(22) Filed: Sep. 13, 2006

(51) Int. Cl. H04B 1/18

(52) U.S. Cl. 455/187.1

(57) ABSTRACT

A communication system and method for dialing a phone number by providing only a nickname. The user of a mobile terminal enters a nickname he wishes to dial to, then adapted software or hardware logic on the mobile terminal converts the nickname to a numeric code and broadcasts signals to a mobile switching center requesting to setup a call to said numeric code. The request to setup a call to the given numeric code is received by the mobile switching center, and is transferred to a communication server. The communication server looks up the numeric code in a translation database to recover the corresponding telephone number to the numeric code, and a call is setup between the corresponding telephone number retrieved and the mobile terminal.

### FIELD OF THE INVENTION

The present invention relates to a method and system for dialing a phone number by specifying only a nickname.

### BACKGROUND OF THE INVENTION

Commercial and personal telephone numbers are hard to memorize because a complete telephone number can be 8 or 10-digits long or even longer.

One solution for commercial telephone numbers has consisted in exploring the fact that each phone key from 2 to 9 is also associated with characters printed along with the digit: from “abc” associated with the digit 2 to “wxyz” associated with the digit 9. In substituting a digit with one of the 3 characters printed on the same digit, the number 1-800-3673-826 can be advertised as 1-800-FORD-VAN. If the user punches each digit associated with the combination FORD VAN, the number 3673 826 will be dialed. This solution is very limited because it requires companies to get new telephone numbers that would fit exactly with the company name or product. These so-called vanity numbers are also hard to get from operators.

Mobile operators often use short numbers that are easy to promote and to remember. Examples of short numbers are: 123, *123 or #123. These short numbers—also known as short-code access numbers—are translated by the mobile operator to full telephone numbers. The user dialing the short-code access number may never be aware of what the full telephone number actually is.

While using short-code access numbers is a very convenient way to promote a telephone number to be used by a mobile terminal user, the current implementations do not work seamlessly. One important shortfall of the current implementation of short-code access numbers is that most of the time, the short-code access numbers work, or work reliably only when the user is within the territory controlled directly by his original mobile operator. When the user is traveling to a different country or region not serviced directly by his mobile operator, a condition known in the telecommunication industry as roaming, the short-code access numbers may not work at all since the short codes are first received by the roaming operator who is not aware of what their real translation is. In an even worse scenario, the same short-code access number used by subscribers of one operator translates to a different service at another operator leading the user to unnecessary phone charges in addition to the inconvenience caused.

In day-to-day life, people normally refer to other people or businesses by name. It would thus be very natural for people to be able to call (dial) other people or a business by entering a name.

### SUMMARY OF THE INVENTION

The present invention relates to a communication method, and a system for implementing said method, for dialing a phone number by providing only a nickname. A communication system is provided comprising a mobile terminal originating a call by nickname request to a communication server, wherein the mobile terminal contains software or hardware logic adapted to generate a call by nickname request, wherein the interaction between said communication server and said mobile terminal is carried out by the following steps:
i) the user of the mobile terminal enters a nickname he wishes to dial to;
ii) the adapted software or hardware logic on the mobile terminal converts the nickname to a numeric code and broadcasts signals to a mobile switching center requesting to setup a call to said numeric code;
iii) the request to setup a call to said numeric code is received by said mobile switching center, and then said request is transferred to the communication server;
iv) the communication server looks up said numeric code in a translation database to recover the corresponding telephone number to said numeric code; and
v) a call is setup between said corresponding telephone number and said mobile terminal.

The process starts by a user of a mobile terminal entering a nickname he wants to dial to, for example, he may enter “john-smith”, “johnny77” or “bigcinema” and then press the “Send” button on his mobile terminal, as if he entered a regular telephone number.

Adapted software or hardware on the mobile terminal intercepts the nickname, and converts it to a numeric code. The adapted software or hardware on the mobile terminal then proceeds by sending signals to a mobile switching center in order to setup a call to said numeric code. The numeric code is typically prefixed by a predetermined prefix that is not understood by the mobile switching center, and thus the call request is transferred to the communication server according to the invention for further processing.

The communication server recognizes the predefined prefix, as a prefix to a numeric code associated with a dialed nickname. The communication server then searches a coupled translation database for the telephone number associated with the received numeric code. Once said associated telephone number is retrieved from the translation database, a call is setup between said telephone number and said mobile terminal.

### BRIEF DESCRIPTION OF THE DRAWINGS

FIG. 1 is an overview of a GSM (Global System for Mobile Communications) network as known in the art.

FIG. 2 is a block diagram of a communication system of the invention operating with an ISUP solution.

FIG. 3 is a block diagram of a communication system of the invention operating within an Intelligent Network.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a dialing method for originating a call by nickname request from a mobile terminal to a communication server, wherein the mobile terminal contains software or hardware logic adapted to generate a call by nickname request, the method comprising the steps of:
i) dialing a nickname on a mobile terminal;
ii) converting said nickname to a numeric code by said adapted software or hardware logic on the mobile terminal and broadcasting signals to a mobile switching center requesting to setup a call to said numeric code;
iii) receiving the request to setup a call to said numeric code by said mobile switching center, and then transferring said request is to the communication server;
iv) looking up said numeric code in a translation database by the communication server and recovering the corresponding telephone number to said numeric code; and
v) setting up a call between said corresponding telephone number and said mobile terminal.

The examples and terminology used herein to describe the invention are taken mainly from a GSM mobile network, and are for illustration purposes only. It will be evident to any person skilled in the art, that the invention is applicable to any present or future mobile network, and that any example provided herein with a GSM terminology should be interpreted as covering any equivalent component or functionality within any other mobile or telephone network.

### GSM and Networking Terminology

The following definitions of GSM and networking terminologies are available from Wikipedia's Internet site on: http://en.wikipedia.org.

DTAP (Direct Transfer Application Part)—DTAP is an application protocol that is employed to pass signaling information between the MS (Mobile Station) and the MSC (Mobile Switching Centre) in a GSM network.

IN (Intelligent Network)—The Intelligent Network or IN, as it is more commonly referred to, is a network architecture for both fixed and mobile telecommunication networks. It allows operators to differentiate themselves by providing value-added services in addition to the standard telecoms services such as GSM services on mobile phones. It can also be regarded as an overlay on the core network.

INAP (Intelligent Network Application Part)—INAP is a signaling protocol used in the intelligent network architecture. It is part of the SS7 protocol suite, typically layered on top of the TCAP protocol. The International Telecommunication Union (ITU) defines several “capability levels” for this protocol, starting with Capability Set 1 (CS-1). A typical application for the IN (Intelligent Network) is a Number Translation service. For example, in the United Kingdom, 0800 numbers are free phone numbers and are translated to a geographic number using an IN platform. The Telephone exchanges decode the 0800 numbers to an IN trigger and the exchange connects to the IN. The Telephone exchange uses TCAP, SCCP and INAP and in IN terms is a Service Switching Point. It sends an INAP Initial Detection Point (IDP) message to the Service Control Point (SCP). The SCP returns an INAP Connect message, which contains a geographic number to forward the call to.

ISUP (ISDN User Part)—The ISDN (Integrated Services Digital Network) User Part or ISUP is part of the Signaling System #7 which is used to set up telephone calls in Public Switched Telephone Networks (PSTN). It is specified by the ITU-T as part of the Q.7xx series. When a telephone call is set up from one subscriber to another, many telephone exchanges will be involved, possibly across international boundaries. To allow the call to be set up correctly, the switches signal call-related information, like the called or calling party number, to the next switch in the network using ISUP messages.

MSISDN (Mobile Station Integrated Services Digital Network) is the mobile equivalent of ISDN and refers to the 15-digit number that is used to refer to a particular mobile station. The MSISDN number starts from the country code. The ITU-T recommendation E.164 defines the international numbering plan that MSISDN is based on.

PSTN—The Public Switched Telephone Network (PSTN) is the concentration of the world's public circuit-switched telephone networks, in much the same way that the Internet is the concentration of the world's public IP-based packet-switched networks. Originally a network of fixed-line analog telephone systems, the PSTN is now almost entirely digital, and presently includes mobile as well as fixed telephones.

SCP (Service Control Point)—An SCP is a standard component of an IN (Intelligent Networks) telephone system which is used to control the service. Standard SCP's in the telecom industry today are deployed using SS7, Sigtran or Session Initiation Protocol (SIP) technologies. The SCP queries the SDP (Service Data Point) which holds the actual database and directory. SCP, using the database from the SDP, identifies the geographical number to which the call is to be routed. This is the same mechanism that is used to route 1-800 numbers. An SCP may also communicate with an “intelligent peripheral” to play voice messages, or prompt for information to the user, such as prepaid long distance using account codes. This is done by implementing feature codes like “#,” which can be used to terminate the input for a username or password or can be used for call forwarding. These are realized using Intelligent Network Application Protocol (INAP) that sits above Transaction Capabilities Application Protocol (TCAP) on the SS7 protocol stack. The TCAP is part of the top or 7th layer of the SS7 layer breakdown.

SCPs are connected with either SSPs or STPs. This is dependent upon the network architecture that the network service provider wants. The most common implementation uses STPs.

SDP (Service Data Points)—In the Intelligent Network (IN) are defined Service Control Points (SCPs) that contain service logic, and Service Data Points (SDPs) that contain data.

STP (Signal Transfer Point) is a switch that relays SS7 messages between SSPs and SCPs. Based on the address fields of the SS7 messages, the STPs route the messages to the appropriate outgoing signaling link. To meet the stringent reliability requirements, STPs are provisioned in mated pairs. Some Universal Mobile Telecommunications System (UMTS) number portability solutions are implemented in STPs. In UMTS, the STP provides Global Title Translation (GTT), which may be used to route queries from a Gateway MSC (GMSC) to the Home Location Register (HLR). Note that for every call to a mobile station (MS), the call is first routed to the MS's Gateway MSC.

TSC (Transit Switching Center)—The TSC simplifies the task of configuring a large network containing many interconnected switching elements, such as mobile switching centers and home location registers. By routing all inter-element signaling through the Transit MSC, operators are able to rationalize signaling routing and reduce time and money spent configuring new elements into the network (Definition provided by Nokia on http://press.nokia.com).

The present invention provides a new dialing method in which a user of a mobile terminal can dial another destination fixed or mobile telephone by providing a nickname instead of the actual telephone number. A given nickname can be associated with more than one telephone number and in that case the caller selects the destination he wants to reach among the different choices available. For example, between home, work, mobile or fax. Any telephone number may also have more than one nickname associated with it. The nickname can include any combination of letters, numbers and symbols available for input on a mobile terminal.

The user of the mobile terminal dials a nickname as if dialing a regular telephone number, that is, by entering the nickname and typically pressing a button associated with a “send” or “call” function. The mobile terminal used in the invention is equipped with adapted software or hardware logic that intercepts the dialed nickname, and converts it instead to a numeric code. Each nickname is converted into a unique numeric code. In one embodiment of the present invention, the numeric code is composed of a predefined prefix and a numeric value. The numeric code or the numeric value may be compressed in order to reduce their size.

The adapted software or hardware logic used by the invention then proceeds to generate a call request to said numeric code. The request to setup a call to said numeric code is broadcasted to a mobile switching center, typically using a signaling channel. In one embodiment of the present invention, the mobile terminal and the mobile switching center communicate by using the DTAP application protocol.

The adapted software or hardware logic can reside on the mobile terminal's SIM card, within the mobile terminal's internal memory, within a memory unit coupled with the mobile terminal or any combination thereof. The adapted software logic can be delivered with the mobile terminal, or downloaded at a later stage by means such as the Internet, a personal computer, a memory unit, over-the-air service provisioning (OTASP), a private or public network or any other available mean for delivering or updating software or hardware logic to the mobile terminal.

When the mobile switching center receives the request to setup a call to said numeric code, it is unable to execute the request on its own since said numeric code is not a valid telephone number. The mobile switching center thus transfers the call setup request to the communication server. The communication server recognizes the numeric code associated with the call setup request as a numeric code originating from a conversion of a nickname. In another embodiment of the present invention, the communication server interprets the predefined prefix of the numeric code as preceding a numeric value representing a conversion from a nickname.

The communication server looks up the numeric code in a translation database coupled to said communication server and retrieves the corresponding telephone number. Once the telephone number corresponding to said numeric code that resulted from the given nickname is retrieved, the call can be set up between the retrieved telephone number and the mobile terminal.

The term “mobile terminal” as referred to herein means any mobile device with telephony capabilities or that can be augmented with telephony capabilities. Examples include, but are not limited to: mobile phones, Personal Digital Assistants (PDA's), portable computers, portable media playing devices, portable game consoles and others.

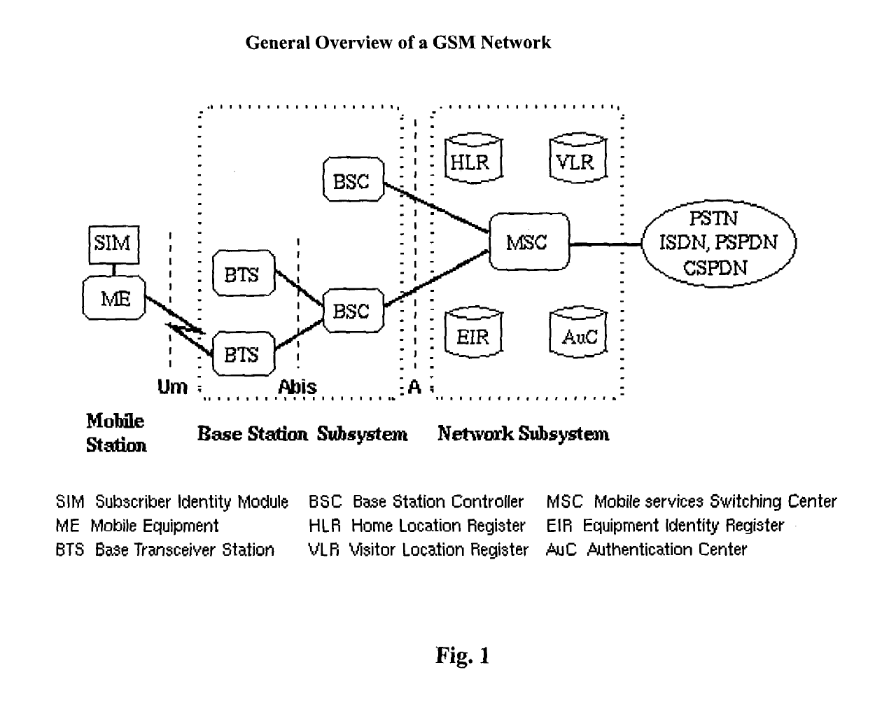

FIG. 1 is an overview of a generic GSM network of the art and its major components. The diagram and description below are available on the following Internet site: http://www.shoshin.uwaterloo.ca/˜jscouria/GSM/gsmreport.html. A GSM network is composed of several functional entities, whose functions and interfaces are specified. The GSM network can be divided into three broad parts: the Mobile Station, carried by the subscriber; the Base Station Subsystem that controls the radio link with the Mobile Station; and the Network Subsystem, the main part of which is the Mobile services Switching Center (MSC), that performs the switching of calls between the mobile users and between mobile and fixed network users. The MSC also handles the mobility management operations. Not shown is the Operations and Maintenance Center, which oversees the proper operation and setup of the network. The Mobile Station and the Base Station Subsystem communicate across the Um interface, also known as the air interface or radio link. The Base Station Subsystem communicates with the Mobile services Switching Center across the A interface.

The mobile station (MS) consists of the mobile equipment (the terminal) and a smart card called the Subscriber Identity Module (SIM). The SIM provides personal mobility, so that the user can have access to subscribed services irrespective of a specific terminal. By inserting the SIM card into another GSM terminal, the user is able to receive calls at that terminal, make calls from that terminal, and receive other subscribed services.

The mobile equipment is uniquely identified by the International Mobile Equipment Identity (IMEI). The SIM card contains the International Mobile Subscriber Identity (IMSI) used to identify the subscriber to the system, a secret key for authentication, and other information. The IMEI and the IMSI are independent, thereby allowing personal mobility. The SIM card may be protected against unauthorized use by a password or personal identity number.

The Base Station Subsystem is composed of two parts: the Base Transceiver Station (BTS) and the Base Station Controller (BSC). These communicate across the standardized Abis interface, allowing (as in the rest of the system) operation between components made by different suppliers.

The Base Transceiver Station houses the radio transceivers that define a cell and handles the radio-link protocols with the Mobile Station. In a large urban area, there will potentially be a large number of BTSs deployed, thus the requirements for a BTS are ruggedness, reliability, portability, and minimum cost.

The Base Station Controller manages the radio resources for one or more BTSs. It handles radio-channel setup, frequency hopping, and handovers. The BSC is the connection between the mobile station and the Mobile service Switching Center (MSC).

The central component of the Network Subsystem is the Mobile services Switching Center (MSC). It acts like a normal switching node of the PSTN or ISDN, and additionally provides all the functionality needed to handle a mobile subscriber, such as registration, authentication, location updating, handovers, and call routing to a roaming subscriber. These services are provided in conjunction with several functional entities, which together form the Network Subsystem. The MSC provides the connection to the fixed networks (such as the PSTN or ISDN). Signaling between functional entities in the Network Subsystem uses Signaling System Number 7 (SS7), used for trunk signaling in ISDN and widely used in current public networks.

The Home Location Register (HLR) and Visitor Location Register (VLR), together with the MSC, provide the call-routing and roaming capabilities of GSM. The HLR contains all the administrative information of each subscriber registered in the corresponding GSM network, along with the current location of the mobile. The location of the mobile is typically in the form of the signaling address of the VLR associated with the mobile station. There is logically one HLR per GSM network, although it may be implemented as a distributed database.

The Visitor Location Register (VLR) contains selected administrative information from the HLR, necessary for call control and provision of the subscribed services, for each mobile currently located in the geographical area controlled by the VLR. Although each functional entity can be implemented as an independent unit, all manufacturers of switching equipment to date implement the VLR together with the MSC, so that the geographical area controlled by the MSC corresponds to that controlled by the VLR, thus simplifying the signaling required. Note that the MSC contains no information about particular mobile stations—this information is stored in the location registers.

The other two registers are used for authentication and security purposes. The Equipment Identity Register (EIR) is a database that contains a list of all valid mobile equipment on the network, where each mobile station is identified by its International Mobile Equipment Identity (IMEI). An IMEI is marked as invalid if it has been reported stolen or is not type approved. The Authentication Center (AuC) is a protected database that stores a copy of the secret key stored in each subscriber's SIM card, which is used for authentication and encryption over the radio channel.

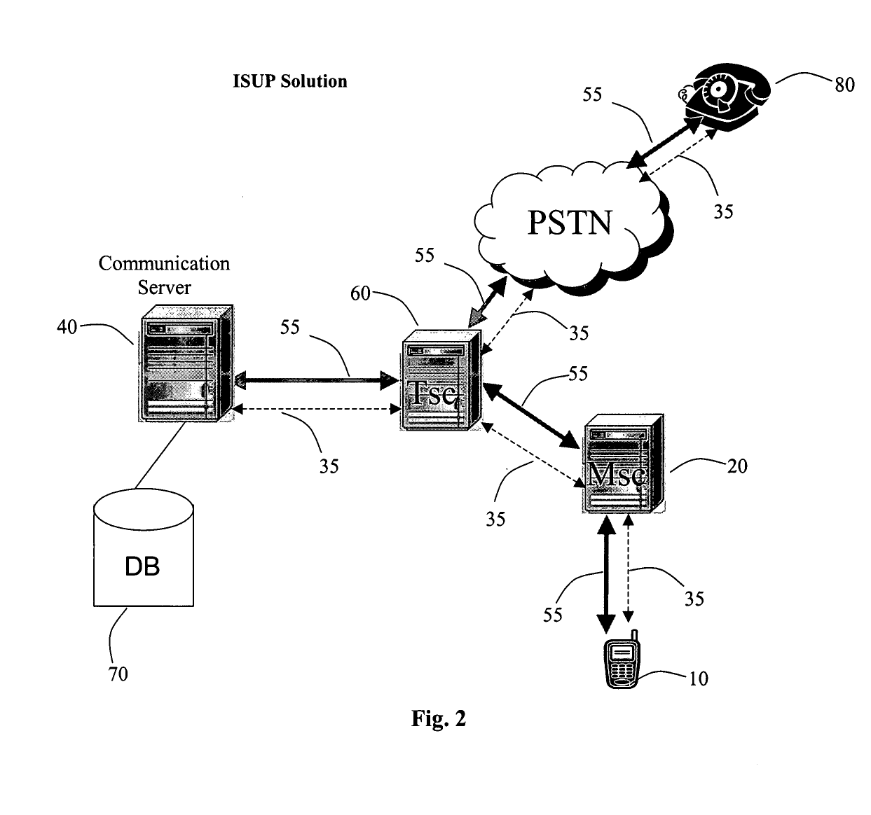

In one embodiment of the present invention, the communication server is implemented in the mobile network in an ISUP solution. FIG. 2 illustrates block diagram of a communication system of the invention operating with an ISUP solution. In an ISUP solution, the mobile terminal 10 issues a call setup request to the MSC 20 via a signaling channel 35. Since the call setup request is not understood by the MSC 20, it is transferred to the communication server 40, via the ISUP protocol, transferring the call in both the voice channel 55 and the signaling channel 35, for further processing. In an ISUP implementation, the MSC 20 sends the communication server 40 an “ISUP In” voice and signaling information via a TSC 60. Once the communication server 40 retrieves the corresponding telephone number from the coupled translation database 70, it issues an “ISUP Out” voice and signaling information, which contains the MSISDN of the mobile terminal 10 (caller) and the corresponding telephone number (called number) to the TSC 60 in order to set up a call between the corresponding telephone number retrieved from the translation database 70 and the mobile terminal 10 originating the call. The TSC 60 then proceeds to send a call setup request with the corresponding telephone number to the destination telephone 80, to perform an outbound call via PSTN or any other available communication mean or network. If the destination telephone 80 responds to the call setup request, it is then connected to the mobile terminal 10 via the MSC 20 by both a voice channel 55 and a signaling channel 35. The destination telephone 80 can be a mobile phone, a fixed-line phone or any other device capable of receiving a telephone communication. Since all Caller ID and MSISDN numbers of the caller and the called number are kept in an ISUP session, the billing plans of all telephone operators are kept intact and the MSC 20 is able to perform all standard billing operations including those of a “Receiving Party Pay” scheme. Furthermore, keeping the Caller ID number between the caller and the called number assures that the receiving party can see the telephone number of the mobile terminal 10 (calling party).

In an ISUP implementation of the invention, the communication server 40 is not directly integrated with the MSC 20. Furthermore, the communication server 40 is responsible for managing the entire call session, and thus is also responsible for the call's billing information. The communication server 40 and the MSC 20 are connected both by a signaling channel 35 and by a voice channel 55 using ISUP links. The ISUP solution is relatively easier to implement and is a good choice for a mobile operator wishing to test or soft launch the service of the invention.

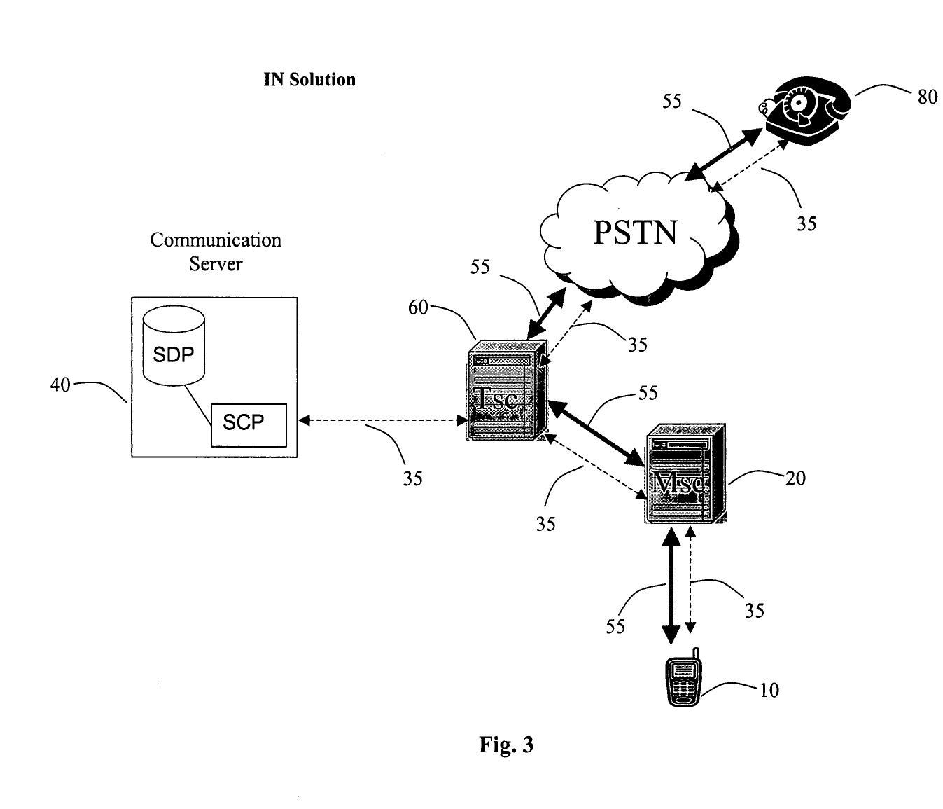

In another embodiment of the present invention, the communication server 40 is implemented in the mobile network in an Intelligent Network (IN) solution. FIG. 3 illustrates a block diagram of a communication system of the invention operating within an Intelligent Network. In an IN solution, the communication server 40 is closely integrated with the MSC 20 and they both communicate by exchanging signaling IDP messages in a signaling channel 35. In contrast to the ISUP solution, in an IN implementation the communication server 40 is more closely integrated with the MSC 20 and is connected to the MSC 20 by a signaling channel 35 only, and not by a voice channel 55. The terms channel, link or trunk are frequently used in the industry in reference to a voice or signaling channel, and refer should thus be interpreted as meaning the same thing. The MSC 20 uses the INAP signaling protocol to ask the communication server 40 to translate the numeric code to a corresponding telephone number. In an IN implementation, the communication server 40 includes an SDP functioning as a translation database 80, while the communication server's 40 logic resides within an SCP.

Once the corresponding telephone number is retrieved by the communication server 40, the MSC 20 forwards the call request to the TSC 60, and the call session is then managed by the MSC 20. The billing information, for example, is handled by the MSC 20 in the same way that all other calls are handled in the mobile network (not involving the communication server 40). Integrating the communication server 40 according to the invention in an IN solution is a more complex task (compared to an ISUP solution), but the result is a more robust implementation from the mobile operator's point of view. It is envisioned by the present invention that mobile operators start by implementing the invention in an ISUP solution, and then move to an IN implementation once the service is successful.

In a further embodiment of the present invention, a chosen nickname may also be used by the user for other applications. For example, the same nickname can be used as the first part of an email address, as in nickname@domain.com, or the nickname can be used as an identifier for an instant messaging application, a Voice over IP (VoIP) application, or any other person-to-person communication application.

A user or a business may adopt several nicknames associated with the same telephone number. In yet another embodiment of the present invention, business rules can be applied to the call request in order to better respond the caller's and called person needs. Several examples of such powerful business rules are provided below, but it is clear that any person skilled in art will immediately understand how to create numerous other business rules for managing calls according to the invention, and all such other business rules are thus viewed to be included in the invention. Examples of business rules for managing a call of the invention include but are not limited to:
Calling a given nickname will result by the caller hearing a standard or custom message, before being connected.
Routing a call to a given nickname to voicemail depending on the time of the call. It can thus be set that all calls after working hours are automatically forward to voicemail.
Forwarding a call to a given nickname to a different telephone number depending on the time of the call. A business person may thus give privileged users a given nickname that connects calls to his office number during working hours and then connects calls to his mobile phone after working hours.
A caller may be automatically transferred to a different telephone number, or a given extension inside a company, depending on the called nickname. Thus, calling a specific nickname can result in the caller being automatically directed to the customer service department without going to through menu system or an operator.

A further advantage of the invention is that it permits users to give out only a unique nickname as a way to call them without disclosing their actual phone number. When a user changes, for example, his mobile phone number all he needs to do then is to have the nickname correspond to his new telephone number. The user does not need to notify anybody of this new number since all calls to his nickname will automatically arrive to his new number.

Although the invention has been described in detail, nevertheless changes and modifications, which do not depart from the teachings of the present invention, will be evident to those skilled in the art. Such changes and modifications are deemed to come within the purview of the present invention and the appended claims.

1. A communication system comprising a mobile terminal originating a call by nickname request to a communication server, wherein the mobile terminal contains software or hardware logic adapted to generate a call by nickname request, wherein the interaction between said communication server and said mobile terminal is carried out by the following steps:
i) the user of the mobile terminal enters a nickname he wishes to dial to;
ii) the adapted software or hardware logic on the mobile terminal converts the nickname to a numeric code and broadcasts signals to a mobile switching center requesting to setup a call to said numeric code;
iii) the request to setup a call to said numeric code is received by said mobile switching center, and then said request is transferred to the communication server;
iv) the communication server looks up said numeric code in a translation database to recover the corresponding telephone number to said numeric code; and
v) a call is setup between said corresponding telephone number and said mobile terminal.

2. A communication system according to claim 1, wherein said numeric code is composed of a predefined prefix and a numeric value.

3. A communication system according to claim 1, wherein communication between the mobile terminal and the mobile switching center is done by using the DTAP application protocol.

4. A communication system according to claim 2, wherein said numeric value is compressed to reduce its size.

5. A communication system according to claim 1, wherein said nickname is alphabetic or alphanumeric.

6. A communication system according to claim 1, wherein said nickname also serves as an identifier for additional applications.

7. A communication system according to claim 1, wherein said additional applications include e-mail, instant messaging, VoIP applications and any other person-to-person communication application.

8. A communication system according to claim 1, wherein the mobile switching center, the TSC and the communication server exchange signals using ISUP.

9. A communication system according to claim 1, wherein said call is managed by said communication server

10. A communication system according to claim 1, wherein billing of said call is performed by said communication server.

11. A communication system according to claim 1, wherein said adapted software or hardware logic resides on a SIM card, within the mobile terminal's internal memory, within a memory unit coupled with the mobile terminal or any combination thereof.

12. A communication system according to claim 1, wherein more than one nicknames are associated with a single corresponding telephone number.

13. A communication system according to claim 1, wherein the person receiving the call from the mobile terminal visualizes the caller's nickname instead of the caller's phone number.

14. A communication system according to claim 1, wherein said corresponding telephone number extracted from said translation database is first passed to a TSC in order to establish a call with said mobile terminal.

15. A communication system according to claim 1, wherein said call request is processed according to business rules.

16. A communication system according to claim 15, wherein said rules include: letting the caller hear a standard or customized message, routing caller to voicemail depending on the time of call, forwarding the call to a different telephone number depending on the time of call, or forwarding the call to a different telephone number depending on the identity of the caller and automatically routing the caller to a specific telephone extension of said corresponding telephone number.

17. A communication system according to claim 1, further including means for replacing the corresponding telephone number associated with a given nickname with a new telephone number.

18. A communication system according to claim 1, wherein said communication server is connected to said mobile switching center via an intelligent network.

19. A communication system according to claim 18, wherein of billing said call is carried out by said mobile switching center.

20. A communication system according to claim 18, wherein call is managed by said mobile switching center.

21. A dialing method for originating a call by nickname request from a mobile terminal to a communication server, wherein the mobile terminal contains software or hardware logic adapted to generate a call by nickname request, the method comprising the steps of:
i) dialing a nickname on a mobile terminal;
ii) converting said nickname to a numeric code by said adapted software or hardware logic on the mobile terminal and broadcasting signals to a mobile switching center requesting to setup a call to said numeric code;
iii) receiving the request to setup a call to said numeric code by said mobile switching center, and then transferring said request to the communication server;
iv) looking up said numeric code in a translation database by the communication server and recovering the corresponding telephone number to said numeric code; and
v) setting up a call between said corresponding telephone number and said mobile terminal.

22. A dialing method according to claim 21, wherein said numeric code is composed of a predefined prefix and a numeric value.

23. A dialing method according to claim 21, wherein communication between the mobile terminal and the mobile switching center is done by using the DTAP application protocol.

24. A dialing method according to claim 24, wherein said numeric value is compressed to reduce its size.

25. A dialing method according to claim 21, wherein said nickname is alphabetic or alphanumeric.

26. A dialing method according to claim 21, wherein said nickname also serves as an identifier for additional applications.

27. A dialing method according to claim 21, wherein said additional applications include e-mail, instant messaging, VoIP applications and any other person-to-person communication application.

28. A dialing method according to claim 21, wherein the mobile switching center, the TSC and the communication server exchange signals using ISUP.

29. A dialing method according to claim 21, wherein said call is managed by said communication server

30. A dialing method according to claim 21, wherein billing said of call is carried out by said communication server.

31. A dialing method according to claim 21, wherein said adapted software or hardware logic resides on a SIM card, within the mobile terminal's internal memory, within a memory unit coupled with the mobile terminal or any combination thereof.

32. A dialing method according to claim 21, wherein said corresponding telephone number extracted from said translation database is first passed to a TSC in order to establish a call with said mobile terminal.

33. A dialing method according to claim 21, wherein more than one nickname are associated with a single corresponding telephone number.

34. A dialing method according to claim 21, wherein the person receiving the call from the mobile terminal visualizes the caller's nickname instead of the caller's phone number.

35. A dialing method according to claim 21, wherein said call request is processed according to business rules.

36. A dialing method according to claim 35, wherein said rules include: letting the caller hear a standard or customized message, routing caller to voicemail depending on the time of call, forwarding the call to a different telephone number depending on the time of call, or forwarding the call to a different telephone number depending on the identity of the caller and automatically routing the caller to a specific telephone extension of said corresponding telephone number.

37. A dialing method according to claim 21, further including means for replacing the corresponding telephone number associated with a given nickname with a new telephone number.

38. A dialing method according to claim 21, wherein said communication server is connected to said mobile switching center via an intelligent network.

39. A dialing method according to claim 38, wherein billing said call is done by said mobile switching center.

40. A dialing method according to claim 38, wherein call is managed by said mobile switching center.
